(19) United States
(12) Patent Application Publication
(10) Pub. No.: US 2009/0027562 A1
(43) Pub. Date: Jan. 29, 2009

(54) Method and Apparatus for Dynamically Switching Off Diversity Mode to Save Power

(75) Inventor: Bernal Antonio Arroyo, San Jose, CA (US)

Correspondence Address: Joseph J. Laks;Thomson Licensing LLC, 2 Independence Way, Patent Operations, PO Box 5312, PRINCETON, NJ, 08543, US

(73) Assignee: THOMSON LICENSING, Boulogne-billancourt (FR)

(21) Appl. No.: 11/989,268

(22) PCT Filed: Aug. 24, 2006
(86) PCT No.: PCT/US2006/033065

§ 371 Date: Jan. 22, 2008

Related U.S. Application Data
(60) Provisional application No. 60/710,888, filed on Aug. 24, 2005.

(51) Int. Cl. H04N 5/63

(52) U.S. Cl. 348/730; 348/E05.127

(57) ABSTRACT

A method and apparatus are provided for controlling power in a mobile device having two receivers operable in combination in a diversity mode. The apparatus includes a signal monitor and analyzer for monitoring and analyzing a signal concurrently received by the two receivers to determine whether or not one of the two receivers can be powered down while still maintaining a threshold quality of the signal for a reception of the signal by the other one of the two receivers. The apparatus further includes a power manager, in signal communication with the signal monitor and analyzer, for powering off at least the one of the two receivers based on an analysis result from the signal monitor and analyzer.

### CROSS-REFERENCE TO RELATED APPLICATIONS

This application claims the benefit of U.S. Provisional Application Ser. No. 60/710,888, filed Aug. 24, 2005, which is incorporated by reference herein in its entirety.

### TECHNICAL FIELD

The present principles relate generally to mobile devices and, more particularly, to a method and apparatus for dynamically switching off diversity mode in a mobile device having at least two receivers.

### BACKGROUND

Some electronic mobile devices include two receivers which can operate in combination to enhance the reception of the signal broadcasted. This mode of operation is known as diversity. However, diversity operation carries with it significant power consumption.

### SUMMARY

These and other drawbacks and disadvantages of the prior art are addressed by the present principles, which are directed to a method and apparatus for dynamically switching off diversity mode in a mobile device having at least two receivers.

According to an aspect of the present principles, there is provided an apparatus for controlling power in a mobile device having two receivers operable in combination in a diversity mode. The apparatus includes a signal monitor and analyzer for monitoring and analyzing a signal concurrently received by the two receivers to determine whether or not one of the two receivers can be powered down while still maintaining a threshold quality of the signal for a reception of the signal by the other one of the two receivers. The apparatus further includes a power manager, in signal communication with the signal monitor and analyzer, for powering off at least the one of the two receivers based on an analysis result from said signal monitor and analyzer.

According to another aspect of the present principles, there is provided a method for controlling power in a mobile device having two receivers operable in combination in a diversity mode. The method includes monitoring and analyzing a signal concurrently received by the two receivers to determine whether or not one of the two receivers can be powered down while still maintaining a threshold quality of the signal for a reception of the signal by the other one of the two receivers. The method also includes powering off at least the one of the two receivers based on an analysis result from the monitoring and analyzing step.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an exemplary apparatus for dynamically switching off diversity mode in a mobile device having at least two receivers, in accordance with an embodiment of the present principles; and

FIG. 2 is a flow diagram for an exemplary method for dynamically switching off diversity mode in a mobile device having at least two receivers, in accordance with an embodiment of the present principles.

### DETAILED DESCRIPTION

The present principles are directed to a method and apparatus for dynamically switching off diversity mode in a mobile device having at least two receivers.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

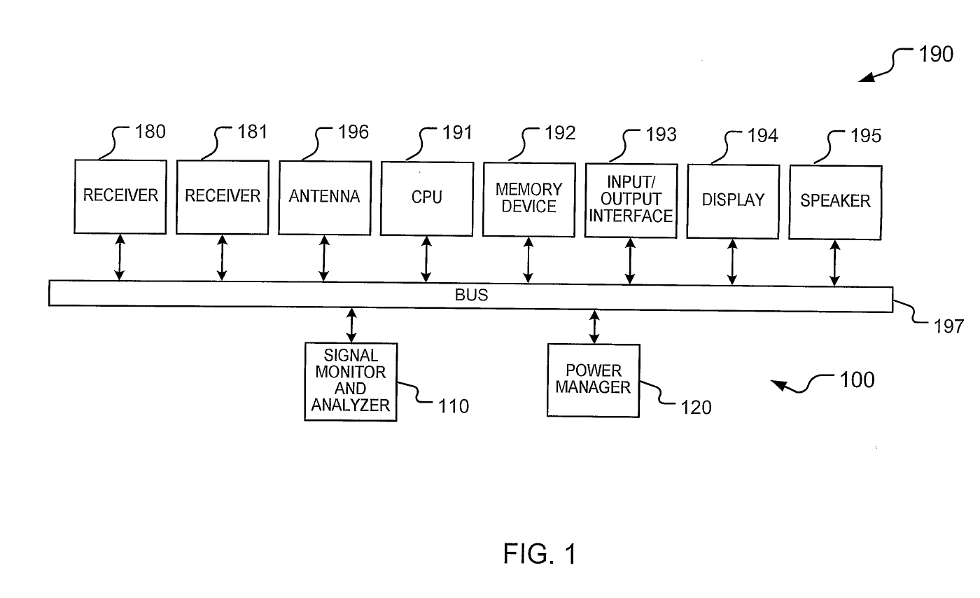

Turning to FIG. 1, an exemplary apparatus for dynamically switching off diversity mode in a mobile device having at least two receivers is indicated generally by the reference numeral 100.

The apparatus 100 is incorporated into a mobile device 190. For the sake of brevity, a brief description of the mobile device 190 is provided. However, one of ordinary skill in this and related arts will contemplate the following and other elements and implementations of a mobile device to which the present principles may be applied, while maintaining the scope of the present principles. The mobile device 190 includes a processor 191, at least one memory device 192, an input/output interface 193, a display 194, at least one speaker 195, antennas 196 and 198, and receivers 180 and 181. Bus 197 interconnects the preceding elements of the mobile device 190.

The processor 191 may be, e.g., a digital signal processor, or may include a digital signal processing portion, for processing digital signals such as audio and video signals. Accordingly, any of the processor 191 and one or more of the receivers 180 and 181 may include corresponding elements or circuitry for performing signal processing including, but not limited to, signal reception, demodulation, and so forth. Such elements and circuitry may include, e.g., digital-to-analog converters (DACs), tuners, and so forth.

The apparatus 100 includes a signal monitor and analyzer 110 and a power manager 120 (hereinafter also collectively referred to herein as “power manager”). Bus 197 also interconnects the preceding elements of the apparatus 100, as well as connecting the elements of the apparatus 100 to the elements of the mobile device 190. Of course, given the teachings of the present principles provided herein, one of ordinary skill in this and related arts will contemplate these and various other elements in an apparatus for dynamically switching off diversity mode in a mobile device, while maintaining the scope of the present principles.

The signal monitor and analyzer 110 monitors and analyzes a signal(s) received by one or more of the receivers 180 and 181 to determine whether or not one of the two receivers 180 and 181 can be powered down while still maintaining a threshold quality of the signal(s). The power manager 120 powers off at least one of the two receivers 180 and 181 based on an analysis result from the signal monitor and analyzer 110.

It is to be appreciated that while the signal monitor and analyzer 110 and the power manager 120 are shown as separate elements from those described as part of the mobile device 190, one of ordinary skill in this and related arts can appreciate that one or more existing components of the mobile device 190 may also be used to implement an apparatus for power management for a mobile device in accordance with the present principles while maintaining the scope of the present principles. For example, the apparatus 100 may use one or more existing elements of the mobile device 190 to implement the present principles. Such existing devices may include, but are not limited to, the processor 191 and the at least one memory device 192.

Some conventional devices, such as the apparatus 100 of FIG. 1, include two receivers which can operate in combination to enhance the reception of the signal broadcasted. This mode of operation is known as diversity. However; diversity operation carries with it significant power consumption.

The present principles provide a method and apparatus for dynamically switching off diversity mode in an electronic device that includes two or more receivers. In an embodiment, the signal of the primary receiver is monitored and the quality is determined via statistical analysis. When the signal is determined to be such that there is no need to have both receivers working in combination, then the secondary receivers is powered down. The signal of the primary received may be monitored constantly, or at pre-specified intervals, to determine if the secondary receiver is needed. An embodiment of the present principles may be implemented dynamically, with the secondary receiver being powered up only when needed.

The present principles allow for significant power consumption savings with minimal or no impact on reception or user experience. The savings in power consumption allow the battery on the unit to last significantly longer than if both receivers were powered-on all the time. An additional benefit is that enhanced reliability since the second receiver does not operate all the time.

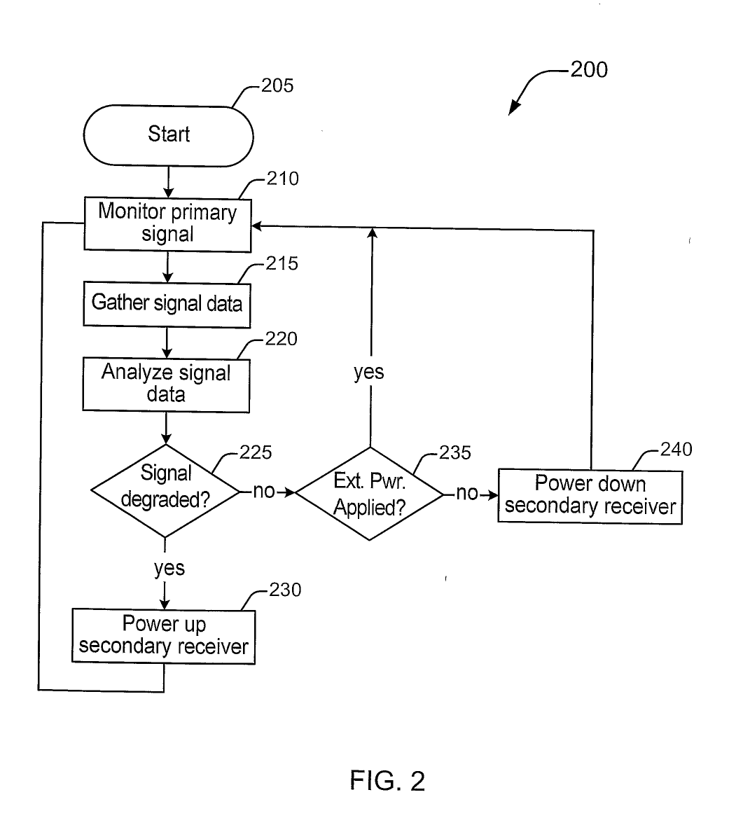

Turning to FIG. 2, an exemplary method for dynamically switching off diversity mode in a mobile device having at least two receivers is indicated generally by the reference numeral 200.

The method 200 includes a start block 205 that passes control to a function block 210. The function block 210 monitors the signal of the primary receiver, and passes control to a function block 215. The function block 215 gathers signal data and passes control to a function block 220. Regarding function block 215, the signal data is gathered when the primary receiver is locked, and the data may include, e.g., signal-to-noise ratio, bit error rate, signal strength, and uncorrected packet count. The data may be gathered over a period of time such that there are at least a pre-determined number of readings for at least some of the above-listed or other parameters prior to analyzing the data.

The function block 220 analyzes the data, and passes control to a decision block 225. Regarding function block 220, the data may be analyzed by statistically determining moving averages on, e.g., the signal-to-noise ratio, the signal strength and the bit error rate, and determining whether or not the signal of the primary receiver is degraded.

The decision block 225 determines whether or not the signal is degraded. If so, then control is passed to a function block 230. Otherwise, control is passed to a decision block 235. Regarding decision block 225, the amount of degradation may be correlated with a point such that reception and, hence, user experience, are starting to be impaired. Thus, for example, one or more parameters may be used to determine the amount of degradation. In an embodiment, the amount of degradation may be based on a comparison to a particular value or range of values, may be based on a shift from a nominal or previous value, and so forth. The thresholds used to determine the extent of signal degradation may be found e.g., via theory and/or experimentation. Given the teachings of the present invention provided herein, one of ordinary skill in this and related arts will contemplate these and various other ways to determine signal degradation for the purpose of powering off diversity mode in accordance with the present principles, while maintaining the scope of the present principles.

The function block 230 powers up the second receiver, and returns control to the function block 210. Regarding function block 230, the second receiver is powered up so that the second receiver, in combination with the primary receiver, will improve signal reception. The secondary receiver may remain powered-up for as long as the signal is degraded. In an embodiment, good reception that does not impair user experience has priority over reducing power consumption under most circumstances.

The decision block 235 determines whether or not external power is applied. If so, then control is returns to function block 210. Otherwise, control is passed to a function block 240. Regarding decision block 230, the condition of whether or not external power is applied may be provided via a message from another entity. For example, another software module may provide the message, the other software module using hardware to track the application of external power. It is to be noted that when external power is applied, the secondary receiver usually not powered off since there is no power savings benefit.

The function block 240 powers down the secondary receiver, and returns control to the function block 210.

A description will now be given of some of the many attendant advantages/features of the present invention, some of which have been mentioned above. For example, one advantage/feature is an apparatus for controlling power in a mobile device having two receivers operable in combination in a diversity mode. The apparatus includes a signal monitor and analyzer for monitoring and analyzing a signal concurrently received by the two receivers to determine whether or not one of the two receivers can be powered down while still maintaining a threshold quality of the signal for a reception of the signal by the other one of the two receivers. The apparatus further includes a power manager, in signal communication with the signal monitor and analyzer, for powering off at least the one of the two receivers based on an analysis result from the signal monitor and analyzer.

Another advantage/feature is the apparatus as described above, wherein the signal monitor and analyzer uses statistical analysis to determine whether or not the one of the two receivers can be powered down while still maintaining a threshold quality of the signal for the reception of the signal by the other one of the two receivers.

Yet another advantage/feature is the apparatus as described above, wherein the two receivers are configured to receive digital video broadcasting signals.

Moreover, another advantage/feature is the apparatus as described above, wherein the two receivers are configured to receive digital terrestrial television signals.

Further, another advantage/feature is the apparatus as described above, wherein the power manager powers off the at least one of the two receivers to reduce battery consumption there by and to enhance reliability of the mobile device by reducing receiver on-time.

Also, another advantage/feature is the apparatus as described above, wherein the power manager reduces battery consumption and enhances a reliability of the mobile device resulting from reduced receiver on-time by powering off the at least one of the two receivers.

Additionally, another advantage/feature is the apparatus as described above, wherein the signal monitor and analyzer analyzes the signal by evaluating at least one of a signal-to-noise ratio, a bit error rate, a signal strength, and an uncorrected packet count.

Moreover, another advantage/feature is the apparatus as described above, wherein the signal monitor and analyzer calculates a moving average of at least one operating parameter of the signal to determine whether or not the one of the two receivers can be powered down while still maintaining the threshold quality of the signal for the reception of the signal by the other one of the two receivers.

Further, another advantage/feature is the apparatus as described above, wherein both of the two receivers are kept powered on irrespective of whether or not the signal meets the threshold quality, when an external power source is applied to the mobile device.

Also, another advantage/feature is the apparatus as described above, wherein the power manager powers on at least the one of the two receivers based on an analysis result from the signal monitor and analyzer indicating a degraded quality less than the threshold quality.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus for controlling power in a mobile device having two receivers operable in combination in a diversity mode, the apparatus comprising:
a signal monitor and analyzer for monitoring and analyzing a signal concurrently received by the two receivers to determine whether or not one of the two receivers can be powered down while still maintaining a threshold quality of the signal for a reception of the signal by the other one of the two receivers; and
a power manager, in signal communication with said signal monitor and analyzer, for powering off at least the one of the two receivers based on an analysis result from said signal monitor and analyzer.

2. The apparatus of claim 1, wherein said signal monitor and analyzer uses statistical analysis to determine whether or not the one of the two receivers can be powered down while still maintaining a threshold quality of the signal for the reception of the signal by the other one of the two receivers.

3. The apparatus of claim 1, wherein the two receivers are configured to receive digital video broadcasting signals.

4. The apparatus of claim 1, wherein the two receivers are configured to receive digital terrestrial television signals.

5. The apparatus of claim 1, wherein said power manager powers off the at least one of the two receivers to reduce battery consumption there by and to enhance reliability of the mobile device by reducing receiver on-time.

6. The apparatus of claim 1, wherein said power manager reduces battery consumption and enhances a reliability of the mobile device resulting from reduced receiver on-time by powering off the at least one of the two receivers.

7. The apparatus of claim 1, wherein said signal monitor and analyzer analyzes the signal by evaluating at least one of a signal-to-noise ratio, a bit error rate, a signal strength, and an uncorrected packet count.

8. The apparatus of claim 1, wherein said signal monitor and analyzer calculates a moving average of at least one operating parameter of the signal to determine whether or not the one of the two receivers can be powered down while still maintaining the threshold quality of the signal for the reception of the signal by the other one of the two receivers.

9. The apparatus of claim 1, wherein both of the two receivers are kept powered on irrespective of whether or not the signal meets the threshold quality, when an external power source is applied to the mobile device.

10. The apparatus of claim 1, wherein said power manager powers on at least the one of the two receivers based on an analysis result from said signal monitor and analyzer indicating a degraded quality less than the threshold quality.

11. A method for controlling power in a mobile device having two receivers operable in combination in a diversity mode, the method comprising:
monitoring and analyzing a signal concurrently received by the two receivers to determine whether or not one of the two receivers can be powered down while still maintaining a threshold quality of the signal for a reception of the signal by the other one of the two receivers; and
powering off at least the one of the two receivers based on an analysis result from said monitoring and analyzing step.

12. The method of claim 11, wherein said monitoring and analyzing step uses statistical analysis to determine whether or not the one of the two receivers can be powered down while still maintaining a threshold quality of the signal for the reception of the signal by the other one of the two receivers.

13. The method of claim 11, wherein the two receivers are configured to receive digital video broadcasting signals.

14. The method of claim 11, wherein the two receivers are configured to receive digital terrestrial television signals.

15. The method of claim 11, wherein said powering step powers off the at least one of the two receivers to reduce battery consumption there by and to enhance reliability of the mobile device by reducing receiver on-time.

16. The method of claim 11, wherein said powering step reduces battery consumption and enhances a reliability of the mobile device resulting from reduced receiver on-time by powering off the at least one of the two receivers.

17. The method of claim 11, wherein said monitoring and analyzing step analyzes the signal by evaluating at least one of a signal-to-noise ratio, a bit error rate, a signal strength, and an uncorrected packet count.

18. The method of claim 11, wherein said monitoring and analyzing step calculates a moving average of at least one operating parameter of the signal to determine whether or not the one of the two receivers can be powered down while still maintaining the threshold quality of the signal for the reception of the signal by the other one of the two receivers.

19. The method of claim 11, further comprising the step of keeping both of the two receivers powered on irrespective of whether or not the signal meets the threshold quality, when an external power source is applied to the mobile device.

20. The method of claim 11, further comprising powering on at least the one of the two receivers based on an analysis result from said monitoring and analyzing step indicating a degraded quality less than the threshold quality.
